(19) United States
(12) Patent Application Publication
(10) Pub. No.: US 2012/0089329 A1
(43) Pub. Date: Apr. 12, 2012

(54) NAVIGATION SYSTEM FOR ELECTRIC VEHICLE AND NAVIGATION SERVICE METHOD THEREOF

(75) Inventors: Sung Yun Kim, Seogwipo (KR); Ji-Hwon Kim, Gwangmyeong (KR); Hyun Cheol Bae, Suwon (KR); Hun Joung Yoon, Hwaseong (KR)

(73) Assignees: KIA MOTORS CORPORATION, Seoul (KR); HYUNDAI MOTOR COMPANY, Seoul (KR)

(21) Appl. No.: 12/953,546

(22) Filed: Nov. 24, 2010

(30) Foreign Application Priority Data
Oct. 8, 2010 (KR) 10-2010-0098313

(51) Int. Cl. G01C 21/36

(52) U.S. Cl. 701/426; 701/439

(57) ABSTRACT

The present invention provides a navigation system for an electric vehicle and a navigation method for the same. The navigation system searches for the location of a charging station and paths where traveling of an electric vehicle is possible; provides the charging station location information and information of the searched paths to a navigation terminal, thereby improving usability and traveling stability of an electric vehicle, resulting in increased road efficiency.

### CROSS-REFERENCE TO RELATED APPLICATION

This application claims under 35 U.S.C. §119(a) the benefit of Korean patent application No. 10-2010-0098313 filed on Oct. 8, 2010, the entire contents of which are incorporated herein by reference.

### BACKGROUND OF THE INVENTION

(a) Technical Field

Embodiments of the present invention relate to navigation technology, and more particularly to a navigation system for an electric vehicle to provide path information specific to the electric vehicle, and a navigation service method for the same.

(b) Background Art

Generally, a navigation system has been widely used to display the current location of a moving object on a map displayed on a screen using information received from a Global Positioning System (GPS). The navigation system provides a variety of navigation information to a vehicle driver, for example, the traveling direction of a moving object, the distance to a destination, the current moving speed of a moving object, a path established by a vehicle driver prior to vehicle driving, the optimum path to the destination, etc.

A navigation system may provide accurate path information and navigation information to a user who is lacks sufficient road information or to drivers who do not have knowledge of the path to their final destination, due to urban development. Because of the increased user convenience provided by a navigation system, many vehicle drivers have installed a navigation system in their vehicles and the use of navigation systems is becoming rapidly popular today

In recent times, in order to eliminate air pollution caused by internal combustion vehicles, many developers have conducted intensive research into vehicles powered by electricity serving as a clean fuel, and some electric vehicles have been sold to the public and are currently on the road. However, the electric vehicle has a limitation in not being able to run on some types of roads, whereas a general internal combustion vehicle can run on all types of roads.

In addition, on a full charge, an electric vehicle generally has a shorter range than an internal combustion vehicle with a full tank of gas. As such, the electric vehicle must be recharged frequently. Furthermore, since there are not many electric vehicles in circulation globally, the number of electric vehicle charging stations is very low. Therefore, electric vehicle drivers experience considerable inconvenience due to the insufficient number of charging stations.

As described above, although the electric vehicle has many limitations with regard to the types of roads they are operable on as opposed to a general internal combustion vehicle, current navigation systems only provide path information and navigation information to a vehicle driver on the assumption that the electric vehicle is able to run on all types of roads as in the general internal combustion vehicle. As a result, it is impossible for a conventional navigation system to be applied to an electric vehicle without any changes.

The above information disclosed in this Background section is only for enhancement of understanding of the background of the invention and therefore it may contain information that does not form the prior art that is already known in this country to a person of ordinary skill in the art.

### BRIEF SUMMARY OF THE INVENTION

Various embodiments of the present invention are directed to providing a navigation system for an electric vehicle and a navigation service method thereof that substantially obviate one or more problems due to limitations and disadvantages of the related art.

In one aspect, the invention provides a navigation system for an electric vehicle which provides path- and navigation-information specific to the electric vehicle, and a navigation service method for the same.

In one embodiment of the present invention, the navigation system for an electric vehicle comprises a data communication unit configured to communicate with a navigation terminal; a database configured to store map information, transportation information, charging station information, and electric vehicle inaccessible road information; and a path search unit wherein, upon receiving a navigation request signal from the data communication unit, the path search unit searches for at least one traveling path composed of only roads where traveling of the electric vehicle is possible using the information stored in the database, and transmitting information about the found traveling path to the navigation terminal.

In another embodiment, the path search unit may configure at least one traveling path composed of only roads where traveling of the electric vehicle is possible from among roads contained in a navigation-requested section using the map information and the electric vehicle inaccessible road information, reflect the transportation information in the configured result, and thus select a specific traveling path by which the electric vehicle takes the shortest time to arrive at a destination from among the corresponding traveling paths. In certain embodiments the path search unit may transmit information regarding the traveling path to the navigation terminal.

In still another embodiment, the path search unit, upon retrieving information about a possible traveling distance of the electric vehicle from the navigation terminal, may search for at least one traveling path shorter than the possible traveling distance. In certain embodiments the path search unit may transmit information regarding the traveling path shorter than the possible traveling distance to the navigation terminal.

In yet another embodiment, when a traveling path shorter than the possible traveling distance is not present, the path search unit may search for at least one traveling path passing through a charging station using the charging station information. In certain embodiments the path search unit may transmit information regarding the charging station to the navigation terminal.

In certain embodiments, the path search unit may search for a traveling path passing through at least one charging station. In certain embodiments the path search unit may transmit information regarding the charging station to the navigation terminal.

In other embodiments, the path search unit may search for a charging station which is located in the traveling path or spaced apart from the traveling path by a predetermined distance or less using the charging station information. In certain embodiments the path search unit may transmit information regarding a found charging station and information of the traveling path.

In another embodiment, when a charging station is not present on the traveling path or spaced apart from the traveling path by a predetermined distance or less, the path search unit may search for a charging station located closest to the traveling path. In certain embodiments the path search unit may transmit information regarding the closest charging station to the navigation terminal.

In certain aspects, the path search unit may search for a charging station located closest to the traveling path, and transmit information of the searched charging station and information of the traveling path.

In accordance with another aspect, the present invention provides a navigation method for an electric vehicle comprising configuring one or more traveling paths composed of only roads where traveling of the electric vehicle is possible from among roads contained in a navigation-requested section using map information and electric vehicle inaccessible road information; selecting a traveling path by which the electric vehicle takes the shortest time to arrive at a destination from among the traveling paths using transportation information; and transmitting information about the selected traveling path to a navigation terminal.

In certain embodiments, the navigation method is performed upon receiving a navigation request signal from the vehicle operator

In certain other embodiments, the traveling path may pass by one or more charging stations.

In yet another embodiment, the configuration step may comprise, upon receiving a navigation request signal and information about a possible traveling distance of the electric vehicle, configuring at least one traveling path shorter than the possible traveling distance.

In certain other embodiments, the configuration step may further comprise, if a traveling path shorter than the possible traveling distance is not present, searching for at least one traveling path passing by a charging station.

The above and other features and advantages of the present invention will be apparent from or are set forth in more detail in the accompanying drawings, which are incorporated in and form a part of this specification, and the following Detailed Description, which together serve to explain by way of example the principles of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a structural diagram illustrating an overall system for providing a navigation system according to an embodiment of the present invention.

FIG. 2 is a block diagram illustrating a navigation server according to an embodiment of the present invention.

FIG. 3 is a flowchart illustrating operations of a navigation system according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DESCRIPTION OF EMBODIMENTS

Reference will now be made in detail to the embodiments of the present invention, examples of which are illustrated in the accompanying drawings. Wherever possible, the same reference numbers will be used throughout the drawings to refer to the same or like parts. The embodiments are described below so as to explain the present invention by referring to the figures.

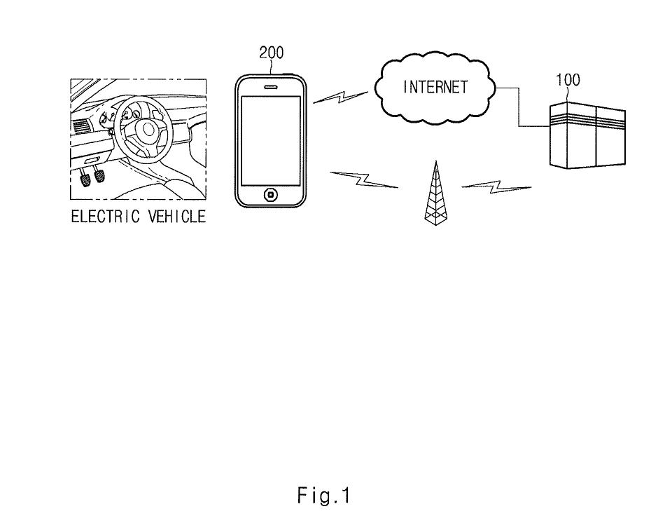

FIG. 1 is a structural diagram illustrating an overall system for providing a navigation system according to an embodiment of the present invention.

Referring to FIG. 1, the navigation system comprises a navigation server 100 and a navigation terminal 200.

The navigation server 100 stores, without limitation, map information, transportation information, charging station information, information (hereinafter referred to as ‘electric vehicle inaccessible road information’) about roads where electric vehicle running is limited, etc. Upon receiving a navigation request information from the navigation terminal 200, the navigation server 100 searches for the shortest path from a departure to a destination using both transportation information of a corresponding region and electric vehicle inaccessible road information, and transmits the retrieved path information to the navigation terminal 200 through a wireless communication network (e.g., a mobile communication network). That is, upon receiving a navigation request signal from the navigation terminal 200, the navigation server 100 configures available traveling paths composed of only some roads (those on which the electric vehicle can run) from among all roads contained in a navigation-requested section, selects the shortest path from a departure to a destination from among the corresponding traveling paths under a current transportation condition, and informs the navigation terminal 200 of the selected path. The navigation server 100 may also inform the navigation terminal 200 of information about any charging stations which are located in the selected path or are spaced apart from the selected path by a predetermined distance or less (or is located closest to the selected path). In response to a request from the navigation terminal 200, the navigation server 100 may configure paths in such a manner that charging stations are contained in the paths (i.e., an electric vehicle can pass through the charging stations while in motion), select the path having the most ideal transportation situation from among the configured paths, and transmit the selected path to the navigation terminal 200. As used herein, the term “most ideal transportation situation” refers to the shortest path chosen from roads on which an electric car can travel.

During execution of the navigation function, the navigation terminal 200 displays path information received from the navigation server 100 on a map displayed on a screen using the pre-stored map information and also displays its own location 200 (or the location of a vehicle including the navigation terminal 200)) using location information received through a GPS antenna on the map displayed on the screen. In addition, the navigation terminal 200 periodically provides the navigation server 100 with traveling information (location information, speed information, etc.) of the road on which the vehicle including the navigation system 200 is traveling. The navigation terminal 200 may be a mobile terminal, such as a smartphone, carried by a vehicle driver, or a telematics terminal installed in an electric vehicle. If the navigation terminal 200 is a mobile terminal separated from the electric vehicle, the navigation terminal 200 communicates with the telematics terminal of the vehicle, such that it may receive information about a battery charging level (i.e., a battery lifetime) and an available traveling distance calculated by a current battery lifetime and then may displays the received information on the screen.

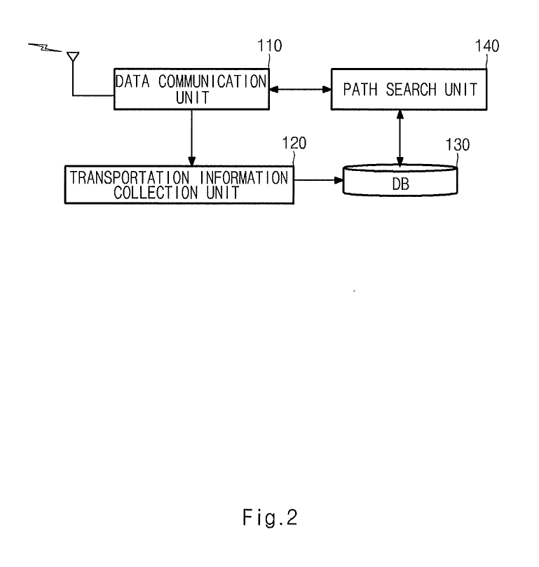

FIG. 2 is a block diagram illustrating a navigation server according to an embodiment of the present invention.

Referring to FIG. 2, the navigation server 100 comprises a data communication unit 110, a transportation information collection unit 120, a database (DB) 130, and a path search unit 140.

The data communication unit 110 is connected to a wired/wireless communication network (e.g., Internet, WiBro, Wi-Fi, WCDMA, etc.), so that it transmits and receives data to and from the navigation terminal 200 over the network. That is, the data communication unit 110 receives a navigation request signal from the navigation terminal 200, and transmits the searched path information to the navigation terminal 200 over the wired/wireless communication network.

The transportation information collection unit 120 collects transportation information of individual sections, and stores the collected transportation information in the database (DB) 130. In this case, the transportation information may include traveling information received from the navigation terminal 200 and transportation information received from a transportation information system (not shown). A variety of methods for collecting such transportation information are well known to those skilled in the art, and the embodiment of the present invention can collect transportation information using any one of such known methods.

The DB 130 stores map information, traffic information, electric vehicle inaccessible road information, charging station information, etc.

Upon receiving a navigation request signal from the data communication unit 110, the path search unit 140 configures available traveling paths composed of only some roads (where the electric vehicle can run) from among all roads contained in a navigation-requested section using map information and electric vehicle inaccessible road information stored in the DB 130, and reflects transportation information in the configured result, so that it selects the shortest path from a departure to a destination from among the corresponding traveling paths under a current transportation condition. In addition, the path search unit 140 determines the presence or absence of a charging station which is located on the selected path or is within a predetermined distance or less from the selected path using the stored charging station information. If a charging station satisfying the corresponding condition is not found, the path search unit 140 searches for the closest charging station to the selected path.

Upon search completion, the path search unit 140 transmits the searched traveling path and the searched charging station information to the navigation terminal 200 through the data communication unit 110. In addition, when the path search unit 140 searches for the traveling path according to a user request or a specific condition, it can reflect the charging station information in the search process in such a manner that the traveling path contains one or more charging stations. For example, assuming that the path search unit 140 further receives information about the traveling distance calculated by a current battery lifetime of a vehicle from the navigation terminal 200 upon receiving the navigation request signal, at least one traveling path, the length of which exceeds the range of the current vehicle, is firstly configured. If such a traveling path is not present, the path search unit 140 configures an objective traveling path in such a manner that the traveling path contains at least one charging station, and selects the shortest traveling path given the current transportation situation. If a traveling path including at least one charging station is not found, the path search unit 140 transmits information about the absence of a traveling path including the charging station to the navigation terminal 200.

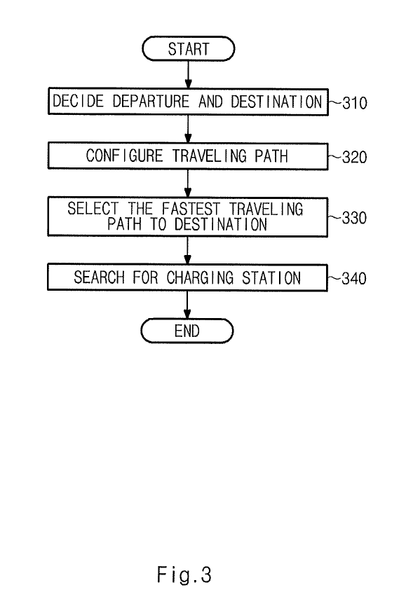

FIG. 3 is a flowchart illustrating operations of a navigation system including the aforementioned constituent elements.

Referring to FIG. 3, when a user (i.e., a vehicle driver/operator) of the navigation terminal 200 rides in a vehicle (i.e., an electric vehicle), selects a navigation menu of the navigation terminal 200, and decides a departure and a destination, the navigation terminal 200 transmits a navigation request signal for a user-desired section to the navigation server 100 (Step 310).

In this case, prior to transmitting the navigation request signal, the navigation terminal 200 communicates with a telematics terminal of the vehicle, receives vehicle information (e.g., current battery life of the vehicle and information about a possible traveling distance (range) calculated by the current battery lifetime, and transmits the vehicle information as well as the navigation request signal. In addition, in the case where the vehicle driver decides the departure and the destination and also selects a menu denoted by ‘Via Charging Station’, the navigation terminal 200 may further transmit the corresponding information for the ‘Via Charging Station’ menu.

Upon receiving the navigation request signal through the data communication unit 110, the path search unit 140 of the navigation server 100 configures possible traveling paths composed of only some roads (where the electric vehicle can run) from among all roads contained in a navigation-requested section using both map information and electric vehicle inaccessible road information stored in the DB 130 (Step 320).

In other words, the path search unit 140 combines the remaining road sections other than some road sections where electric vehicle traveling is inaccessible, so that it configures all available paths between departure and destination points decided by the vehicle driver.

In this case, through vehicle information received simultaneously with the navigation request signal, the path search unit 140 may omit some traveling paths each having a length longer than a possible traveling distance calculated by a current battery lifetime, from among all configured traveling paths. If each of the configured traveling paths is longer than the possible traveling distance of the vehicle or if the vehicle driver selects the menu item ‘Via Charging Station’, the path search unit 140 reflects the charging station information stored in the DB 130 in the search process, so that it configures traveling paths in such a manner that each traveling path includes at least one charging station.

Upon completion of configuration of such traveling paths, the path search unit 140 reflects transportation information of individual sections contained in the configured traveling paths in the search process, so that it selects the traveling path that will allow the vehicle to reach the destination in the shortest amount of time, from among the configured traveling paths under a current transportation situation (Step 330).

Thereafter, upon receiving the charging station information stored in the DB 130, the path search unit 140 searches for at least one charging station which is located on the traveling path selected at step S330 or is spaced apart from the selected path by a predetermined distance or less, and transmits the searched charging station information along with the traveling path information to the navigation terminal 200 through the data communication unit 110 (Step 340).

In this case, when the traveling path is configured at step S320, assuming that the charging station information is pre-included in the above traveling path, the process for searching for the charging station information at step S340 may be omitted as necessary.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may combine the above embodiments in a variety of different ways.

For example, the above-mentioned embodiments of the present invention have exemplarily disclosed that the path search unit 140 searches for a charging station located closest to the traveling path only when a charging station located in the traveling path or spaced apart from the traveling path by a predetermined distance or less is not found. However, if necessary, the navigation system according to the present invention may initially search for only a specific charging station located closest to the traveling path without searching for the above charging stations located in the traveling path or spaced apart from the traveling path by a predetermined distance or less.

In addition, according to the embodiment of the present invention, when a vehicle driver selects the menu item ‘Via Charging Station’ or when a traveling path longer than a possible traveling distance is not present, the navigation system according to the present invention can search for at least one traveling path passing by a charging station. However, if necessary, the navigation system may search for all traveling paths that pass by one or more charging stations.

As apparent from the above description, the navigation system for electric vehicles and the method for the same according to the present invention enable an electric vehicle driver to use a navigation service, thereby improving usability and traveling stability of an electric vehicle, resulting in increased road efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A navigation system for an electric vehicle comprising:
a data communication unit configured to communicate with a navigation terminal;
a database configured to store map information, transportation information, charging station information, and electric vehicle inaccessible road information; and
a path search unit wherein, upon receiving a navigation request signal from the data communication unit, the path search unit searches for at least one traveling path composed of only roads where traveling of the electric vehicle is possible using the information stored in the database, and transmitting information about the found traveling path to the navigation terminal.

2. The navigation system according to claim 1, wherein the path search unit configures at least one traveling path composed of only roads where traveling of the electric vehicle is possible from among roads contained in a navigation-requested section using the map information and the electric vehicle inaccessible road information, reflects the transportation information in the configured result, and thus selects a specific traveling path by which the electric vehicle takes the shortest time to arrive at a destination from among the corresponding traveling paths.

3. The navigation system according to claim 2, wherein the path search unit, upon retrieving information about a possible traveling distance of the electric vehicle from the navigation terminal, searches for at least one traveling path shorter than the possible traveling distance.

4. The navigation system according to claim 3, wherein if when the path search unit has determined that a traveling path shorter than the possible traveling distance is not present, then the path search unit further searches for at least one traveling path passing through a charging station using the charging station information.

5. The navigation system according to claim 2, wherein the path search unit further searches for a traveling path passing through at least one charging station.

6. The navigation system according to claim 1, wherein the path search unit searches for a charging station which is located in the traveling path or spaced apart from the traveling path by a predetermined distance or less using the charging station information, and transmits information regarding the found charging station and information of the traveling path to the navigation terminal.

7. The navigation system according to claim 6, wherein, if the path search unit determines that a charging station which is located on the traveling path or spaced apart from the traveling path by a predetermined distance or less is not present, then the path search unit further searches for a charging station located closest to the traveling path

8. The navigation system according to claim 1, wherein the path search unit searches for a charging station located closest to the traveling path, and transmits information of the searched charging station and information of the traveling path.

9. A navigation method for an electric vehicle, the method comprising:
configuring one or more traveling paths composed of only roads where traveling of the electric vehicle is possible, from among roads contained in a navigation-requested section using map information and electric vehicle inaccessible road information;
selecting a traveling path by which the electric vehicle takes the shortest time to arrive at a destination from among the traveling paths using transportation information; and
transmitting information about the selected traveling path to a navigation terminal.

10. The navigation method according to claim 9, wherein the traveling path passes by one or more charging stations.

11. The navigation method according to claim 9, wherein the configuration step comprises configuring at least one traveling path shorter than the possible traveling distance.

12. The navigation method according to claim 11, wherein the configuration step further comprises searching for at least one traveling path passing by the charging station, if a traveling path shorter than the possible traveling distance is not present,
